(19) United States
(12) Patent Application Publication
(10) Pub. No.: US 2015/0318885 A1
(43) Pub. Date: Nov. 5, 2015

(54) MOBILE ELECTRONIC DEVICE HOLDER

(71) Applicant: Justis Earle, Soquel, CA (US)

(72) Inventor: Justis Earle, Soquel, CA (US)

(21) Appl. No.: 14/702,712

(22) Filed: May 2, 2015

Related U.S. Application Data
(60) Provisional application No. 61/987,706, filed on May 2, 2014.
(60) Provisional application No. 62/100,441, filed on Jan. 6, 2015.

(51) Int. Cl. H04B 1/3827

(52) U.S. Cl. CPC H04B 1/385; H04B 2001/3861

(57) ABSTRACT

A mobile electronic device holder (1, 11, 61, 151) is provided, comprising a first section (2, 12, 62), configured for attachment to at least a user's hand (9); and a second section (4, 14, 24, 34, 44, 64, 154), configured for connection with a mobile electronic device. According to the invention, the second section (4, 14, 24, 34, 44, 64, 154) is movably coupled to the first section (2, 12, 62) to provide at least a handheld position and a storage position of said mobile electronic device. A secure fixation of a mobile electronic device to a user's hand (9) is thus provided, while simultaneously providing increased usability, e.g., for photographing and/or filming purposes, such as during sporting events or other activities.

### CROSS-REFERENCE TO RELATED APPLICATIONS

This application claims the benefit of U.S. Provisional Patent Application No. 61/987,706 filed May 2, 2014, and U.S. Provisional Patent Application No. 62/100,441, filed Jan. 6, 2015. The contents of both aforesaid applications are hereby incorporated by reference in their entireties for all purposes to the extent that such contents is not inconsistent with the present application.

### TECHNICAL FIELD

The present invention generally relates to mobile electronic device accessories and in particular to mobile electronic device holders and cases that allow carrying a mobile electronic device. The device holder may be optimized in particular for photographing and filming purposes, but may also be designed for use in a method of electronic device operation.

### BACKGROUND

In the recent past, it has become customary to carry mobile electronic devices during everyday life. These devices, also referred to as “personal electronic devices”, typically fit into pockets of clothing, in handbags, or briefcases and thus can be easily carried with one during daily routine. Like many other electronic devices, most types of mobile electronic devices can be damaged when accidentally dropped. Accordingly, cases are available to protect a mobile electronic device from damage due to, e.g., accidental drops or falls.

For certain activities, which are particularly prone to accidental damage of a carried mobile electronic device, such as walking, running, or other outdoor activities, special armband cases are available that allow to affix the device to an upper arm of a user.

The present inventor has recognized that a typical problem with the available cases is that the latter only allow a limited usage of the device when within the case. For example, using the above mentioned armband case with a mobile phone or smart phone; it is typically necessary to remove the mobile phone from the case when answering a phone call or a video call or when taking a photo or video. As will be apparent, this can be a cumbersome process, in particular during sport or outdoor activities. In addition, once the mobile electronic device is removed from the case, a risk of damage to the device is present.

Accordingly an object exists to provide a mobile electronic device holder, which enables improved usability of said mobile electronic device while keeping the device safely attached to a user or object even during operation.

### SUMMARY

The following summary is provided to facilitate an understanding of some of the innovative features unique to the present invention and is not intended to be a full description. A full appreciation of the various aspects of the invention can be gained by taking the entire specification, claims, drawings, and abstract as a whole.

Various embodiments of the invention are directed to a mobile electronic device holder, which allows to securely carry a mobile electronic device, such as a mobile or cordless phone, a smart phone, a camera, a tablet computer, a smart watch, a wearable electronic device, a pager, a GPS device, a fitness tracker, a music player, or a similar mobile electronics or computing device.

Some of the embodiments of the mobile electronic device holder described herein allow an attachment of the mobile electronic device to a user's hand, which is particularly advantageous during sport or outdoor activities.

According to one aspect of the present invention, a mobile electronic device holder is provided, which comprises at least a first section and a second section. The first section is configured for attachment to at least a user's hand and the second section is configured for reception of or connection with a mobile electronic device. Furthermore, the second section is movably coupled to the first section to provide at least a handheld position and a storage position of said mobile electronic device.

According to a further aspect of the present invention, a method of mobile electronic device operation is provided with a wearable electronic device holder comprising a first section and a second section. Said first section is configured for attachment to at least a user's hand and said second section is configured for reception of or connection with a mobile electronic device. According to the present method, said mobile device is brought from a storage position to a handheld position while being safely attached to the user's hand.

The basic idea of one or more embodiments of the present invention is to provide a secure fixation of a mobile electronic device to a user's hand, while allowing to position the mobile electronic device in at least two positions, namely said handheld position and said storage position. The present invention thus avoids or at least substantially reduces the risk of an accidental drop of and thus damage to the carried mobile electronic device, while providing increased usability, e.g., for photographing and/or filming purposes, such as during sporting events or other activities.

These and other aspects of the invention will be apparent from and elucidated with reference to the embodiments described hereinafter.

### BRIEF DESCRIPTION OF THE DRAWINGS

In the drawings, like reference numerals refer to like parts throughout the various figures unless otherwise specified. For a better understanding of the present invention, reference will be made to the following detailed description of preferred embodiments, which is to be read in conjunction with the accompanying drawings, wherein:

FIG. 1 shows a first embodiment of a mobile electronic device holder according to the present invention in a plan schematic view,

FIGS. 2A-2C show the embodiment of FIG. 1 in plan schematic views according to different operating positions,

FIGS. 3A-3E show schematic, partial views of a mobile electronic device holder according to a second embodiment of the present invention,

FIGS. 4A-4D show an embodiment of a mobile electronic device holder according to FIG. 3 in different operating positions,

FIGS. 5A-5D show further embodiments of a second section of a mobile electronic device holder according to the present invention,

FIG. 6 shows a further embodiment of a mobile electronic device holder according to the present invention in a perspective view in a storage position,

FIG. 7 shows the embodiment of FIG. 6 in a front view in a handheld position,

FIG. 8 shows the embodiment of FIG. 6 in a back view in the handheld position of FIG. 7,

FIG. 9 shows the embodiment of FIGS. 6-8 in a partial perspective, exploded view,

FIG. 10A shows the embodiment of FIGS. 6-8 in a partial perspective, exploded view,

FIG. 10B shows a further embodiment of a swivel mount for a mobile electronic device holder in a perspective, exploded view,

FIGS. 11A-11C show further embodiments of a pivoting arm and a second section of a mobile electronic device holder according to the present invention,

FIGS. 12A-12D show a further embodiment of a second section of a mobile electronic device holder according to the present invention,

FIG. 13 shows a further embodiment of a second section of a mobile electronic device holder according to the present invention,

FIGS. 14A-14C show embodiments of a mount adaptor for use with the embodiment of FIGS. 6-13,

FIG. 15 shows a further embodiment of a mobile electronic device holder according to the present invention in a partial perspective view and

FIG. 16 shows the embodiment of FIG. 15 in a partial perspective, exploded view.

### DETAILED DESCRIPTION OF PREFERRED EMBODIMENTS

Technical features described in this application can be used to construct various embodiments of a mobile electronic device holder and a method of mobile electronic device operation according to the description herein.

In the field of mobile device accessories, it has been identified by the present inventor that certain activities are particularly prone to accidental damage of a carried mobile electronic device, such as walking, running, or other outdoor activities, and that a typical problem with available cases is that the latter only allow a limited usage of the device when within the case.

In one approach, the present inventor has recognized that a mobile electronic device holder may be provided, which allows improved usability of said mobile electronic device while keeping the device safely attached to a user or object even during operation or use of the electronic device.

By providing a mobile electronic device holder, as discussed in various embodiments herein, safety against accidental damage to the mobile electronic device and usability thereof is improved simultaneously, as will be discussed in the following in more detail.

In the current explanation of preferred embodiments, the terms “connected to/with” or “coupled with” are used to indicate a physical connection between at least two components, devices, units, parts, sections, or assemblies. Such connection may be direct between the respective components, devices, units, parts, or assemblies or indirect, i.e. over intermediate components, devices, units, parts, sections, or assemblies. The connection may be permanent or temporary.

It is noted that the term “mobile electronic device” herein is used interchangeably with “personal electronic device” and may refer to any mobile electronic device that can be easily carried during daily routine, i.e. a battery operated device or a device that does not need a permanent mains connection during operation. The term “mobile electronic device” may for example refer to a mobile or cordless phone, a smart phone, a camera, a tablet computer, a smart watch, a wearable electronic device, a pager, a GPS device, a fitness tracker, a music player, or a similar mobile electronics or computing device.

According to one aspect of the present invention, a mobile electronic device holder is provided, which comprises at least a first section and a second section. The first section is configured for attachment at least to a user's hand and the second section is configured for connection with—or reception of—at least one mobile electronic device. Furthermore, the second section is movably coupled to the first section to allow at least a handheld position and a storage position of said mobile electronic device.

As discussed in the preceding, the mobile electronic device holder according to the present aspect comprises at least a first section and a second section, which are movably coupled with each other allowing at least said handheld position and said storage position of said mobile electronic device when said mobile electronic device is connected with said second section. Certainly, the mobile electronic device holder may comprise further components, sections, or assemblies depending among others on the respective device type of said mobile electronic device. For example, for some mobile electronic devices, such as for some POV (point-of-view) cameras, a dedicated mount adaptor may be necessary, which may be formed integrally with said second section or separately thereof. Furthermore, different second sections may be provided that are adapted for different mobile electronic devices, which increases the versatility of the mobile electronic device holder further.

The first section of the mobile electronic device holder of this aspect is configured for attachment to at least a user's hand. The first section may for example comprise one or more of a hand strap, glove, and fixation ring. The first section may in addition be adapted to be connected to other parts of the user's body, such as the thumb, wrist, or arm, for further improved stability.

In addition to the above, the first section may also be configured to allow the present mobile electronic device holder to be connected to inanimate objects, such as for example a tree, signpost, rear view mirror, and/or bicycle to allow fixed photo, filming, or viewing applications. In one example, the first section is made at least in part of textile, such as nylon, Cordura, Spandura, Airprene, Leather, Lycra, Tricot, Velcro®, and/or neoprene material. In another alternative or additional example, the first section may comprise magnets and/or springs, e.g., to allow affixing the first section to the above-mentioned inanimate objects.

The second section of the mobile electronic device holder according to the present aspect is configured for connection with a mobile electronic device. In this context, it is noted that the term “configured for connection with a mobile electronic device” is understood to include any arrangement, to which the mobile electronic device can be connected or attached to, and also arrangements, in which the mobile electronic device can at least in part be received. The second section thus may be configured for reception of said mobile electronic device, e.g., using a suitable receptacle. While it is possible that the entire device is received in said second section, it is also possible that only a part of the mobile electronic device is received in the second section.

The second section may for example comprise a bracket, case, pouch, mount, or any other type of device for a secure connection with or reception of said mobile electronic device. The second section may be made of any suitable material, such as plastic, glass-reinforced nylon, and/or metal. In one embodiment, the second section is waterproof and thus allows storing the mobile electronic device safely, e.g., for aquatics. For example, said second section may comprise a pouch with a re-sealable and waterproof closing mechanism, such as a plastic zipper.

As discussed in the preceding, the first section and the second section are movably coupled so that it is possible to bring said mobile electronic device at least in said handheld position and in said storage position. At least during operation, the two positions differ from each other, i.e. the physical location of the mobile electronic device with respect to the user's hand in said handheld position differs from the physical location of the mobile electronic device in said storage position. In both positions, as well as during transitioning from one of the mentioned positions to the respective other position, the second section is securely coupled to the first section and thus during operation, the mobile electronic device is securely coupled to the user's hand to avoid an accidental drop of the device.

For example, the second section may in an embodiment be translationally, rotationally, and/or pivotably coupled to the first section to provide at least said handheld position and said storage position.

It is noted that an operation of said mobile electronic device may be possible in both positions. When referring to “operating position”, “operation”, or “use” of the mobile electronic device holder according to the embodiments described, it is assumed that the first section is attached at least to the user's hand and that the mobile electronic device is connected to or received within said second section. Accordingly, the user wears the mobile electronic device holder during operation.

In said handheld position, the mobile electronic device in one embodiment may be positioned so that the mobile electronic device can be operated with one or more fingers of the user's respective hand, i.e. the hand to which during use of the device holder, the first section attaches to. An exemplary handheld position may be a position similar to those of hand held video or digital still cameras, where the mobile electronic device is positioned between a plurality of fingers of the user's hand.

It is noted that in the context of this application, the thumb of the user's hand is considered a finger.

The storage position, as discussed in the preceding, differs from said handheld position. In one additional or alternative embodiment, the mobile electronic device holder is configured, so that in said storage position, the fingers of the user's respective hand can be freely used without substantial interference from the mobile electronic device. In one further additional or alternative embodiment, the mobile electronic device holder is configured, so that in said storage position, the mobile electronic device cannot be operated with the fingers of the user's respective hand.

According to a further additional or alternative embodiment, said first section is configured to be worn at least partly around the metacarpus of the user's hand. For example, the first section according to the present embodiment may comprise a hand strap, i.e. a loop, belt, or strap, adapted to be worn around an intermediate part of the hand, such as the area, arranged in the direction of the fingers/arm between the base of the four fingers and the base of the user's thumb.

As discussed in the preceding, the second section is movably coupled to the first section. In one embodiment, the second section is pivotably coupled/connected to the first section. The present embodiment enables a particularly simple and quick shift of the mobile electronic device from the storage position to the handheld position and vice versa.

In a further additional or alternative embodiment, the second section is connected with said first section to pivot around a first pivot axis. For example, the first and second sections may be configured so that during operation, the first pivot axis is substantially (+/−20°) parallel to the longitudinal axis of the fingers of the user's respective hand. The first and second section may for example be configured with a “180 degree” locking pivot mechanism to pivot around the first pivot axis and to lock in said handheld and storage positions. The locking mechanism may, e.g., comprise a lever to provide that the pivoting movement is locked safely. Alternatively, the locking mechanism may comprise a latching type and/or friction force setup, which can be operated by applying a predefined force, which may be set higher than usual forces that are applied to the mobile electronic device holder.

In a further additional or alternative embodiment, a pivoting arm is provided and coupled between said first and second section. Said pivoting arm may in one example be pivotably connected with said first section to pivot around said first pivot axis.

The pivoting arm according to the above embodiments may be of any suitable type. For example, the pivoting arm may be provided rigid, e.g., made of plastic material. In another additional or alternative example, the pivoting arm is at least partly flexible, e.g., made from flexible rubber, nylon and/or “bungee-style” material, to provide a “cable-like” setup of the pivoting arm. In case said first section comprises a hand strap, the pivoting arm may be connected with said hand strap so that during operation, the first pivot axis is located in the area between the index finger and thumb of the user's respective hand.

In another embodiment, said pivoting arm may alternatively or additional be pivotably coupled/connected with said second section to pivot around a second pivot axis, which second pivot axis is substantially parallel to said first pivot axis.

The “dual-swivel” setup according to the present embodiment allows, e.g., to substantially reposition the mobile electronic device when transitioning from said storage position to said handheld position and vice versa. For example, it is possible to operate the mobile electronic device holder using the dual-swivel setup in an embodiment, where during operation and in said storage position, the mobile electronic device extends substantially parallel to the plane of the user's hand and in said handheld position, the mobile electronic device extends substantially perpendicular to the plane of the user's hand, e.g., on a side of the hand.

In a further additional or alternative embodiment, the second section is connected with said first section and/or said pivoting arm to pivot around a perpendicular swivel axis, also referred to as “perpendicular/third pivot axis”, which perpendicular swivel axis is arranged substantially perpendicular to the first and/or second pivot axis. The present embodiment may be particularly useful for filming or still imaging purposes, since it allows a further degree of freedom.

In one additional example, the mobile electronic device holder is configured with a “360 degree” swivel mechanism to pivot around the perpendicular swivel axis. The swivel mechanism may be of locking-type to lock the second section in defined angular positions. Regarding the details of the locking mechanism, reference is made to the preceding discussion of the locking pivot mechanism in the context of the first pivot axis.

According to another additional or alternative embodiment, the mobile electronic device holder comprises at least one detachable connector, to detach said first section from said second section. The detachable connector allows to quickly remove said second section and thus the mobile electronic device from the hand of the user. The detachable connector may be of any suitable type, provided that a safe connection of the first and second sections during operation is provided. The detachable connector may be provided between the first section and the second section, the first section and the pivoting arm, and/or the second section and the pivoting arm.

In one example, the detachable connector is of “quick-connect” type, and/or of “push-to-disconnect” type, so that it is possible to detach said first and second sections easily with one hand.

In a further embodiment, the detachable connector is a detachable swivel connector, i.e. providing the discussed swivel or pivoting movement. The detachable swivel connector allows a swivel or pivoting movement at least along one of said first, second, and perpendicular/third swivel/pivot axis and simultaneously allows the user to selectively detach said first section from said second section. In one example, the detachable swivel connector allows rotational movement around the perpendicular swivel axis.

The detachable swivel connector may be of any suitable type. In one example, the detachable swivel connector comprises a retractable ball bearing. The detachable swivel connector may comprise a cylindrical first member that engages concentrically in a cylindrical second member, the latter of which having an inner diameter, which corresponds to or is greater than the outer diameter of the first member. The first member may comprise a number of retractable spring-loaded spherical locking members, arranged radially, which engage in a corresponding radial groove, formed on an inner surface of the cylindrical second member. Engagement of the first and second member of the detachable swivel connector is provided by pushing the first member into the second member, until the spring-loaded spherical members lock into the groove of said second member. Disengagement in this case may be provided by an actuator, such as a button, which pulls the spherical members inwards, i.e. against the force of the springs. A corresponding detachable swivel connector is commercially available from Uncle Mikes/Bushnell Outdoor Products under product number MO10112 (1″).

In one additional embodiment, said detachable swivel connector is arranged between said second section and said pivoting arm.

According to another additional or alternative embodiment, the mobile electronic device holder is configured, so that in said storage position, the mobile electronic device is arranged in the area of the back of the user's respective hand. In one example, the mobile electronic device in said storage position is arranged between the metacarpophalangeal joints and the wrist of the user's respective hand. In another additional or alternative example, the mobile electronic device in said storage position is arranged substantially parallel to the back of the user's respective hand. The present embodiment allows hands free action shots (film or still photography) or simply safe storage of the device when not in use.

In one additional or alternative embodiment, the mobile electronic device holder is configured, so that in said handheld position, said mobile electronic device is at least partly positioned between the thumb and at least one further finger of the user's respective hand. The present embodiment allows a particularly stable filming or still photography position. For example, the mobile electronic device holder may be configured, so that in said handheld position, the second section and/or said mobile electronic device rests upon the thumb of the user′ respective hand, while the device is guided and operable by the index and/or middle finger of the same hand.

In another additional or alternative embodiment, the mobile electronic device holder is configured so that in said handheld position the mobile electronic device is arranged substantially perpendicular to the arrangement of the mobile electronic device in said storage position. For example, in the above embodiment, where in said storage position the mobile electronic device is substantially parallel to the back of the user's respective hand, in said handheld position, the mobile electronic device is provided substantially perpendicular to the back of the user's respective hand.

According to another additional or alternative embodiment, the first section comprises a first locking member and the second section comprises a second locking member. Herein, said first and second locking members are configured to lock said mobile electronic device in said storage position.

The two locking members according to the present embodiment may be of any suitable type to keep the mobile electronic device safely in said storage position. In the above-discussed example of a pivoting arm, the two locking members may be arranged to lock pivoting movement of the pivoting arm around at least one of said pivot axes. An actuator may be provided to allow the user to disable the locking. In another example, the first and/or second section may comprise magnets or a spring-loaded mechanism to keep the mobile electronic device in said storage position. The spring-loaded mechanism may in one example be of “switchblade-knife” type, where a button or lever is actuated and the device automatically transitions from the storage position into the handheld position or a further “holding position”. The setup, e.g., rigidity and placement, of the spring-loaded mechanism may also hold the electronic device in place in both positions and may be used in addition to or alternatively to Velcro® fasteners.

In another additional or alternative example, the first and second section may comprise two interlocking Velcro® fasteners, e.g., suitable hook-and-loop fasteners. The present example may be particularly suitable in case the first section comprises a hand strap or glove, as discussed in the preceding. Here, a first Velcro® fastener may be provided on the hand strap or glove in a position, that is located during operation in the area of the back of the user's respective hand. A second counterpart Velcro® fastener may be provided on one surface of the second section.

In another additional or alternative embodiment and as discussed briefly in the preceding, the first section comprises a hand strap. The hand strap may be of any suitable type, e.g., to be worn at least partly around the metacarpus of the user's respective hand. The hand strap may be made from any suitable material, such as textile, nylon, Cordura, Spandura, Airprene, Leather, Lycra, Tricot, Velcro®, rubber, neoprene, or a combination thereof.

In one additional example, the hand strap is adjustable, i.e. allowing for a length adjustment by a corresponding adjustment mechanism and/or at least one stretchable section of the hand strap to accommodate varying hand anatomies of different users.

In another additional or alternative example, the first section further comprises a safety wrist strap and/or a safety thumb strap for further improved safety against accidental damage or loss and to provide further improved stability during operation. The safety wrist/thumb strap may in one example be connected to or integrated with said hand strap, providing a “glove-like” setup.

According to another additional or alternative embodiment, the second section comprises a receptacle for said mobile electronic device. The receptacle may be of any suitable type, such as for example, a bracket, a case, a mount, a pouch, or any other device for a secure reception of said mobile electronic device. In one example the receptacle is configured so that the mobile electronic device is removable from said receptacle. Alternatively or additionally, the receptacle may be removable from further components of said second section, such as a base unit of said second section. In another alternative or additional example, the receptacle is pivotably coupled to said base unit.

The receptacle may in one example be made, e.g., from plastic material, textile, neoprene or a combination thereof. The receptacle in another additional or alternative example may be provided flexible and/or waterproof.

According to a further additional or alternative embodiment, the second section is configured for permanent attachment to a mobile electronic device or a case for a mobile electronic device. For example, the second section may be configured for adhesive bonding to said mobile electronic device or case, which provides a very cost effective setup. In the case of a setup including said detachable connector, as discussed in the preceding, it is certainly possible to use different mobile electronic devices with the mobile electronic device holder according to the present embodiment by using a plurality of second sections, providing a “set-like” arrangement.

According to a second aspect of the present invention, a wearable electronic device mount is provided, comprising a hand strap to be worn around a user's hand and a mounting base for a mobile electronic device, wherein said mounting base is connected with said hand strap so that said mobile electronic device can be brought at least from a first operating position (handheld position) into a second operation position (storage position) and vice versa. In said first operating position, the mobile electronic device is in contact with at least one finger of the user's respective hand and in said second operating position, said mobile electronic device is arranged on the back of the user's respective hand.

According to a further aspect of the present invention, a mobile electronic device holder comprising a first section is provided. Said first section is configured for attachment at least to a user's hand. Additionally, said first section is connectable to a second section, which second section is configured for reception of or connection with a mobile electronic device.

Both, said first and/or said second section may be configured according to one or more of the embodiments described in the preceding and following description. For example, the first and second sections may be connectable, so that at least a handheld position and a storage position of said mobile electronic device is provided when the first and second sections are connected/coupled. The connection may additionally be detachable, e.g., using a detachable (swivel) connector. In addition or alternatively to the above, the first section may also be configured to allow the present mobile electronic device holder to be connected to inanimate objects, such as for example a tree, signpost, rear view mirror, and/or bicycle to allow fixed photo, filming, or viewing applications.

According to another aspect of the present invention, a mobile electronic device holder comprising a second section is provided, which second section is configured for reception of or connection with a mobile electronic device. In addition, said second section is connectable to a first section, which first section is configured for attachment to at least a user's hand.

Again, both, said first and/or said second section may be configured according to one or more of the embodiments described in the preceding and following description. For example, the first and second sections may be connectable, so that at least a handheld position and a storage position of said mobile electronic device is provided when the first and second sections are connected/coupled. The connection may additionally be detachable, e.g., using a detachable (swivel) connector. In addition or alternatively to the above, the first section may also be configured to allow the present mobile electronic device holder to be connected to inanimate objects, such as for example a tree, signpost, rear view mirror, and/or bicycle to allow fixed photo, filming, or viewing applications.

Reference will now be made to the drawings in which the various elements of embodiments will be given numerical designations and in which embodiments will be discussed so as to enable one skilled in the art to make and use the invention.

Specific reference to components, devices, units, parts, assemblies, and other elements are not intended to be limiting. Further, it is understood that like parts bear the same reference numerals and/or the same designation, when referring to alternate figures. It is furthermore noted that the figures are schematic and provided for guidance to the skilled reader and are not necessarily drawn to scale. Rather, the various drawing scales, aspect ratios, and numbers of components shown in the figures may be purposely distorted to make certain features or relationships easier to understand.

FIG. 1 shows a first embodiment of a mobile electronic device holder 1 in a plan and schematic view. The device holder 1 comprises a first section 2, which in this case comprises a textile hand strap made partly from Velcro® hook-and-loop material for removable and adjustable attachment to a user's hand 9. The strap 2 also allows the device holder 1 to be affixed to inanimate objects, e.g. for fixed photographing or filming applications/opportunities. The first section 2 further comprises a thumb strap or thumb holder 3, so that the first section 2 can be securely attached to the user's hand 9 without a risk of slipping.

The device holder 1 further comprises a second section 4 comprising a clear or transparent case, which is adapted to accommodate a mobile electronic device, such as a mobile or cordless phone, a smart phone, a camera, a tablet computer, a smart watch, a wearable electronic device, a pager, a GPS device, a fitness tracker, music player, or similar mobile electronics or computing device. Note that the plane of a display or camera unit of the mobile electronic device would be arranged perpendicular to the drawing plane of FIG. 1 when said device is accommodated in the second section 4.

The first 2 and second sections 4 are connected with each other over pivoting arm 5. The pivoting arm 5 comprises a first connector arm 5a and a second connector arm 5b, wherein the first connector arm 5a is connected with the hand strap of the first section 2 and the second connector arm 5b with the case of the second section 4, respectively. The first 5a and second 5b connector arms are furthermore pivotably connected with each other to allow pivoting around a first pivot axis 6, arranged perpendicular to the drawing plane of FIG. 1. The connection of second connector arm 5b and the second section 4 and thus the case comprises a swivel joint (not shown) and thus allows rotating the second section 4 against the second connector arm 5b around a further “perpendicular” swivel axis, arranged perpendicular to the first pivot axis. While the first pivot axis 6 allows at least a 90° pivot, the swivel joint in this example allows 360° of rotational movement.

Due to the above-mentioned setup of the mobile/personal electronic device holder 1, multiple operating positions are provided. As discussed in the preceding, the device holder 1 adjusts using pivoting arm 5, which provides two pivot or swivel mechanisms and thus operating versatility in at least two main positions.

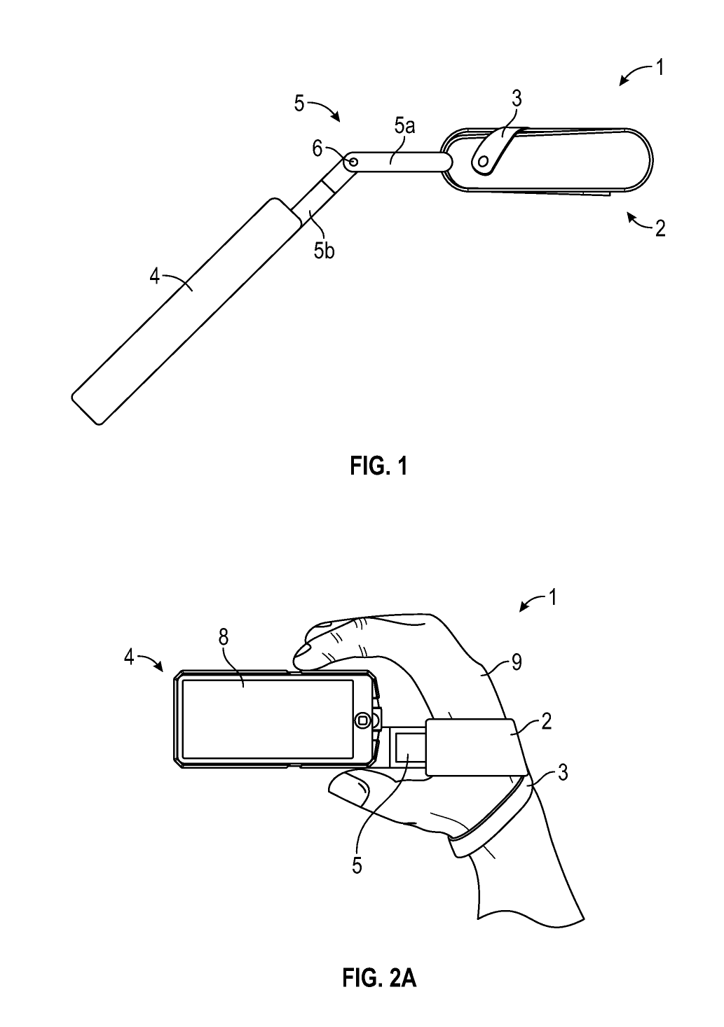

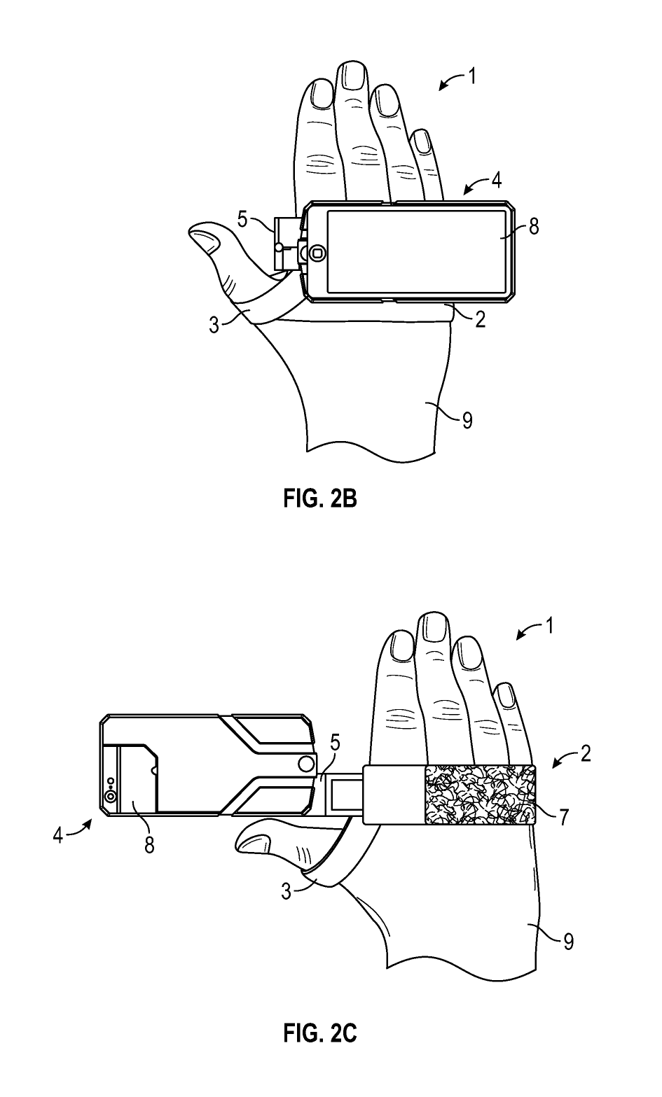

In a handheld position, also referred to as “camera”, “filming” or “first operating” position, the device holder 1 allows the user to take stable photos or videos with one hand, e.g., using a smart phone 8 without the fear of dropping or losing the phone in the process. The handheld position is similar to those of hand held video or still cameras. A storage position, also referred to as “back-of-the-hand” or “second operating” position, allows hands free action shots or storing of the electronic device when not in use. Both positions of the device holder 1 are shown in the schematic views of FIGS. 2A-2C, where the device holder 1 is worn on a user's hand 9.

FIG. 2A shows the device holder 1 with a smart phone 8 in the handheld position, where the smart phone 8 and the case of the second section 4 is positioned between the thumb and the index and middle finger of the user's respective hand, i.e. the hand to which the first section 2 of the device holder 1 is attached to during use. This position is very stable and thus particularly suitable for filming or still picture applications.

FIG. 2B shows the device holder 1 with the smart phone 8 in the storage position on the back of the user's hand 9. As will be apparent from the FIG., the smart phone 8 is operable in the storage position, while the fingers of the user's respective hand are free for other purposes. As shown, it is possible to use the smart phone 8 also in this position for filming or still picture applications, as the back camera of most smart phones available today is arranged in an area of the device, which in the storage position protrudes beyond the user's hand, as shown in FIG. 2B. The hand strap of the first section 2 comprises a Velcro® (hook-and-loop) fastener 7, as shown in FIG. 2C, to retain or lock the smart phone in the storage position.

FIG. 2C shows a “transition position” or “intermediate position” when bringing the device holder 1 from the handheld position into the storage position and vice versa.

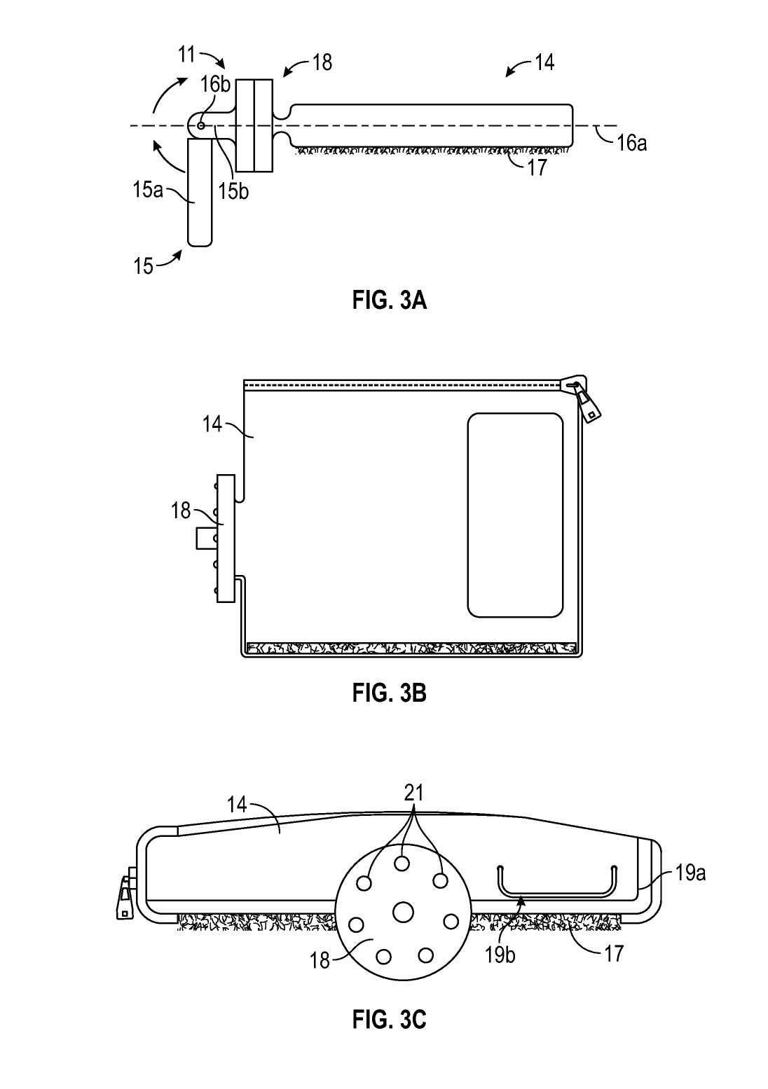

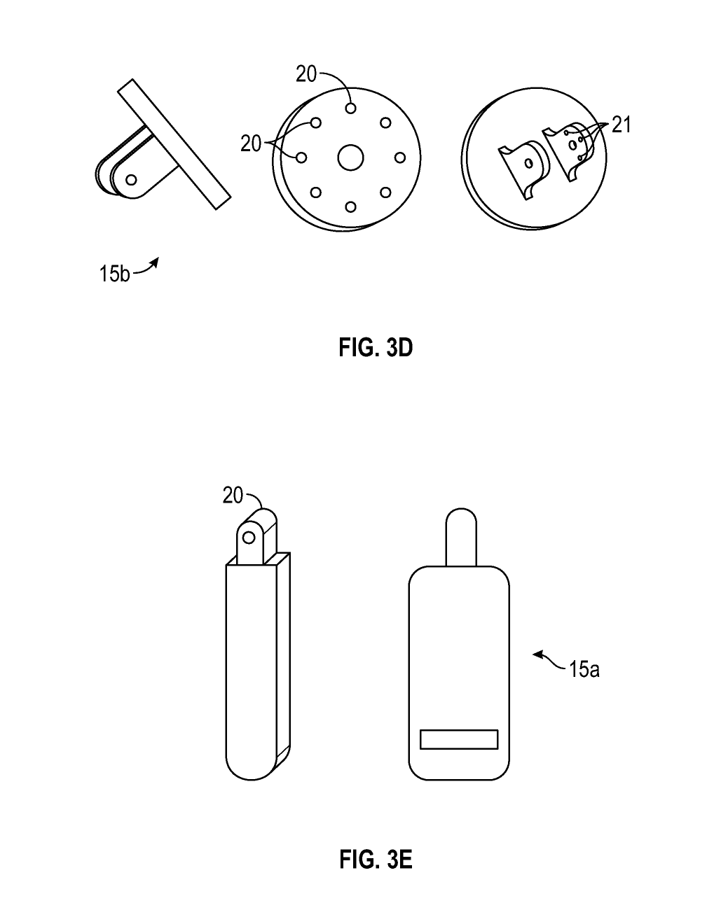

FIGS. 3A-3E show schematic partial views of a second embodiment of the mobile electronic device holder 11 according to the present invention. For reasons of clarity, the first section 12 of the electronic device holder 11 is not shown in FIGS. 3A-3E. However, the setup of the first section 12 may correspond to the preceding discussion of the embodiment of FIGS. 1 and 2, e.g., comprising at least the shown hand strap.

Corresponding to the embodiment described in the preceding, second section 14 is provided to accommodate a mobile electronic device, as will be apparent from the side view of FIG. 3A. Pivoting arm 15 with first connector arm 15a and second connector arm 15b, together with the second section 14, allows pivoting/rotational movement, as discussed in the preceding.

The three components of this subassembly are described in more detail in the following.

According to the present exemplary embodiment, the second section 14 comprises a case with a zipper, as can be seen from FIGS. 3B and 3C, to open and close the case and thus to quickly and securely bring the mobile electronic device into engagement with the device holder 11. The case may be in one example particularly adapted to accommodate smart phone 8.

The case comprises a clear cover and has a back opening, positioned so that the back camera of the smart phone 8 has a clear view for photography purposes. The case has openings in appropriate places to accommodate headphones, a credit card reader (e.g. a Square™ reader), and/or to access the headphone, USB, data, and power connectors. It should be noted that the case may be of versatile type, i.e., adapted to accommodate a variety of smart phones, or that the case may be specifically adapted to a specific type, model, or series of smart phones.

The case according to the present embodiment is made from elastic material and comprises a Velcro® (hook-and-loop) fastener 17 on a backside, so as to engage with the counterpart Velcro® (hook-and-loop) fastener 7 in the storage position, provided on the first section 2, 12 of the device holder 11, as discussed in the preceding.

As can be seen from FIG. 3C, the case further comprises a 90° accessory table 19a to accommodate a credit card reader or other accessory devices and an accessory safety strap 19b to secure the accessory device and to prevent detachment of the accessory device even during movement and/or shock.

Referring again to FIG. 3A, the second section 14 is connected with pivoting arm 15 and in particular with the second connector arm 15b of pivoting arm 15 over a disc-shaped swivel joint 18 to allow pivoting of the second section 14 relative to second connector arm 15b around perpendicular swivel axis 16a. The second connector arm 15b on its other end is pivotably connected to first connector arm 15a to allow rotation of the aforesaid connector arms 15a and 15b against each other around first pivot axis 16b, arranged perpendicular to the drawing plane of FIG. 3A. The first pivot axis 16b and the perpendicular swivel axis 16a are thus arranged substantially perpendicular to each other. The first connector arm 15a is connected to the first section 11 (not shown in FIGS. 3A-3E), as discussed in the preceding with reference to FIGS. 1-2.

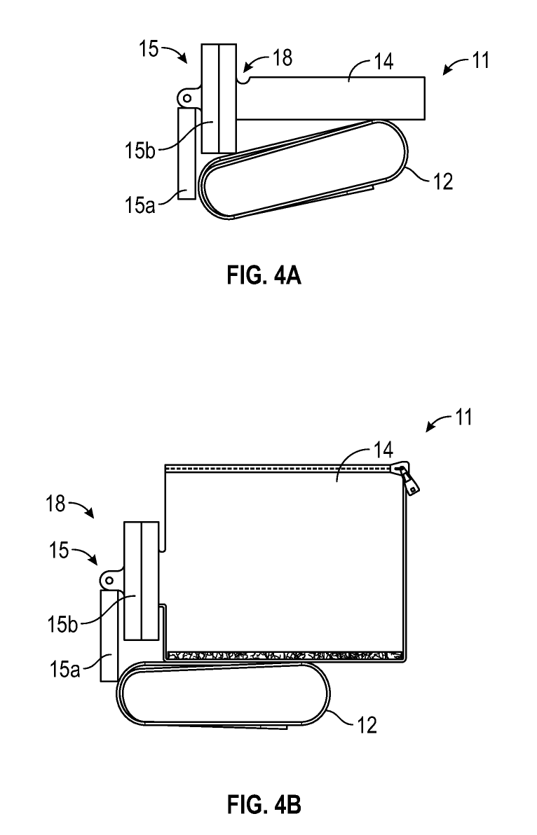

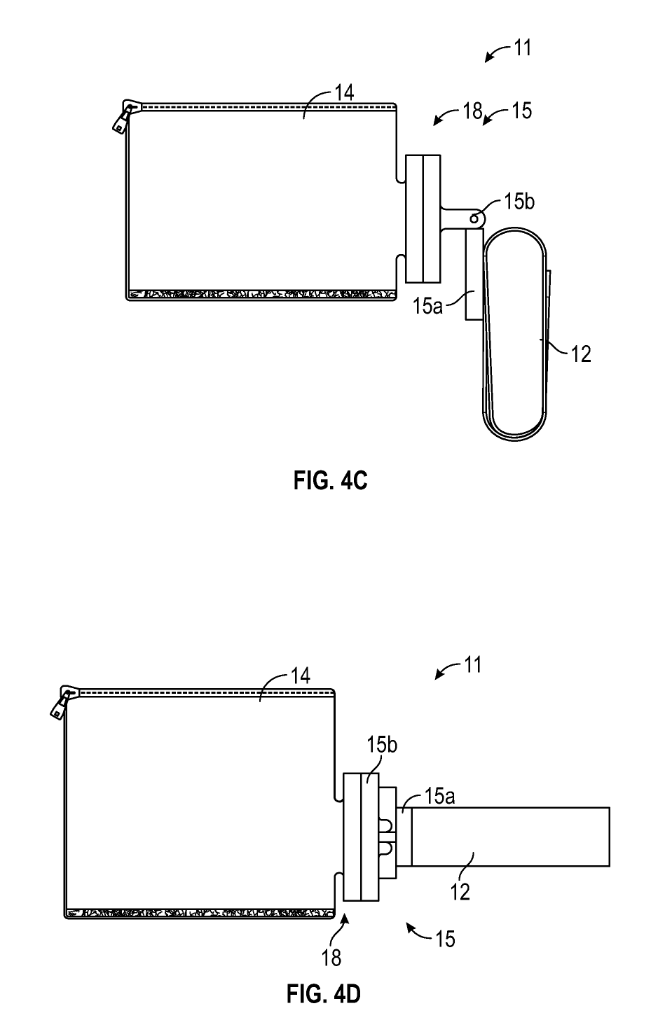

As will be apparent from detail drawings of FIGS. 3C-3E, the first 15a and second connector arm 15b as well as the disc shaped swivel joint 18 comprise indentations 20 and corresponding protrusions 21, which during use engage with each other to provide a “latching” swivel/pivot adjustment for rotation around both pivot axes, the first pivot axis 16b and the perpendicular swivel axis 16a. The present embodiment thus allows retaining the second section 14 and thus the mobile electronic device safely in multiple positions, some of which are shown in FIGS. 4A-4D.

FIGS. 4A-4D show an embodiment of a mobile electronic device holder 11 comprising the second section 14 and pivoting arm 15 according to FIGS. 3A-3E and the first section 12, which in FIGS. 4A-4D corresponds to the embodiment of FIGS. 1-2.

FIG. 4A shows the mobile electronic device holder 11 in the storage position, i.e., where during use the mobile electronic device is arranged in the area of the back of the user's hand and thus corresponding to FIG. 2B. FIG. 4D shows the mobile electronic device holder 11 in the handheld position, corresponding to FIG. 2A. FIGS. 4B and 4C show further, intermediate positions.

As mentioned in the preceding, the second section 4, 14 of the mobile electronic device holder 1, 11 may be adapted to the specific mobile electronic device, but also for the respective application.

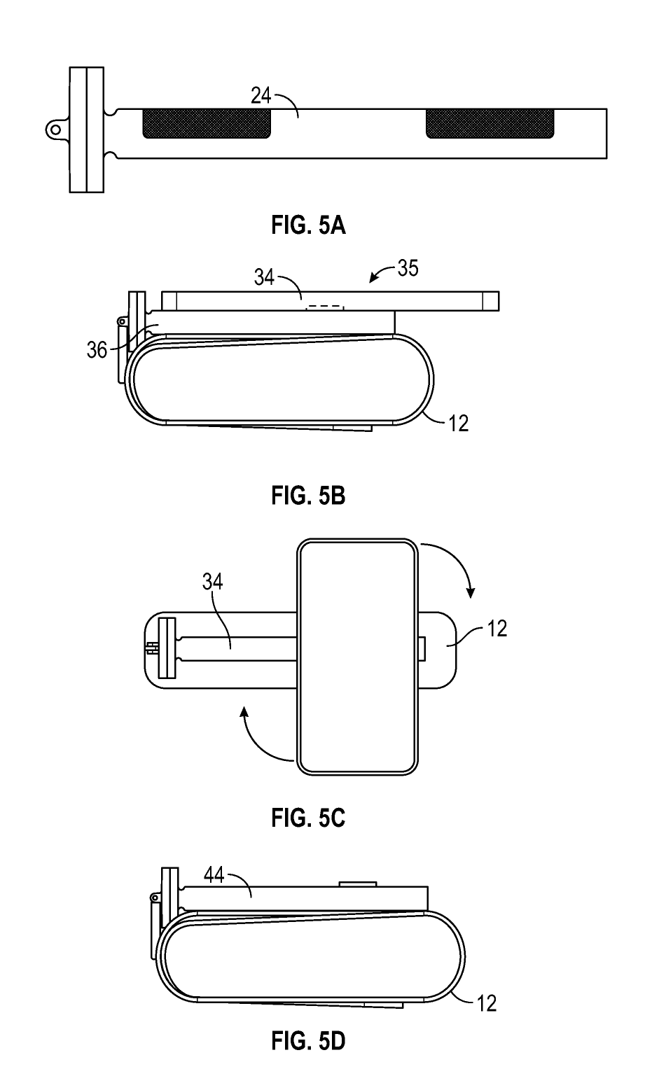

FIGS. 5A-5C show further embodiments of a second section 24, 34, 44 of a mobile electronic device holder for use with any of the embodiments described in the preceding and following text. The shown embodiments, as will be apparent from FIGS. 5A-5C, substantially correspond to the embodiments of FIGS. 1-4, with the exception of a water proof case of second section 24 (FIG. 5A), a sliding groove mechanism 35 provided as a part of second section 34 (FIGS. 5B and 5C), and a removable case of second section 44 with an optional universal mount adaptor, such as, e.g., a GoPro™ mount. The sliding groove mechanism 35 allowing a 360° pivoting of the case with reference to a base mount 36 of the second section 34, as shown in FIG. 5C.

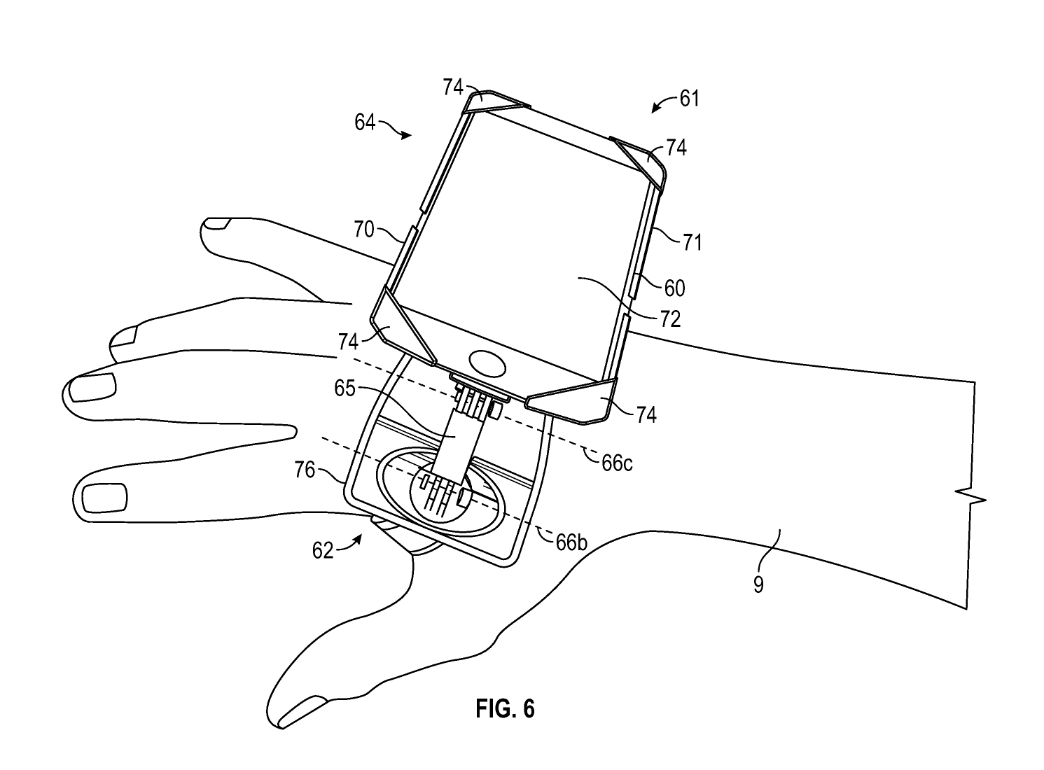

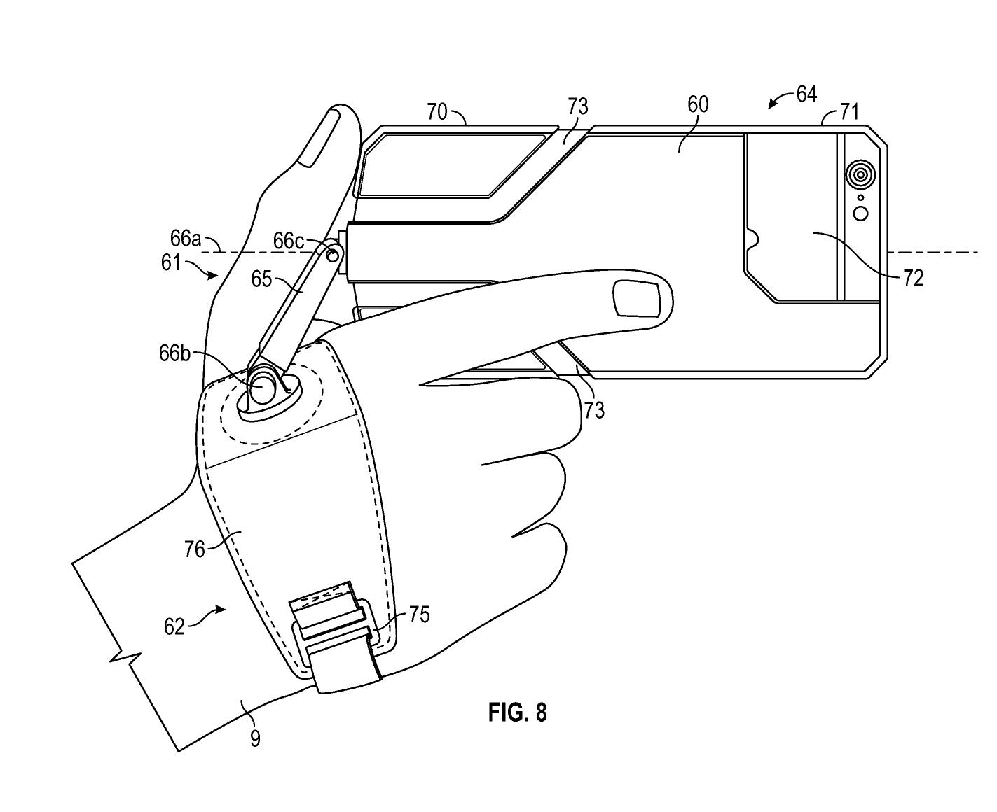

FIG. 6 shows a further embodiment of a mobile device holder 61 in a perspective view during use. As can bee seen from the FIG., the mobile device holder 61 is again configured to receive or accommodate a smart phone 72 in a second section 64. According to the present embodiment, the second section 64 comprises a case 60 made from co-molded plastics. Channels 73 (cf. FIG. 8), arranged close to pivoting arm 65, are comprised of flexible plastics, which allow the bottom to stretch to accommodate the smart phone 72. Hook-like corner retainer clips 74 secure the smart phone 72 in place in case 60. The case 60 comprises a Velcro® (hook-and-loop) fastener on its backside (not shown).

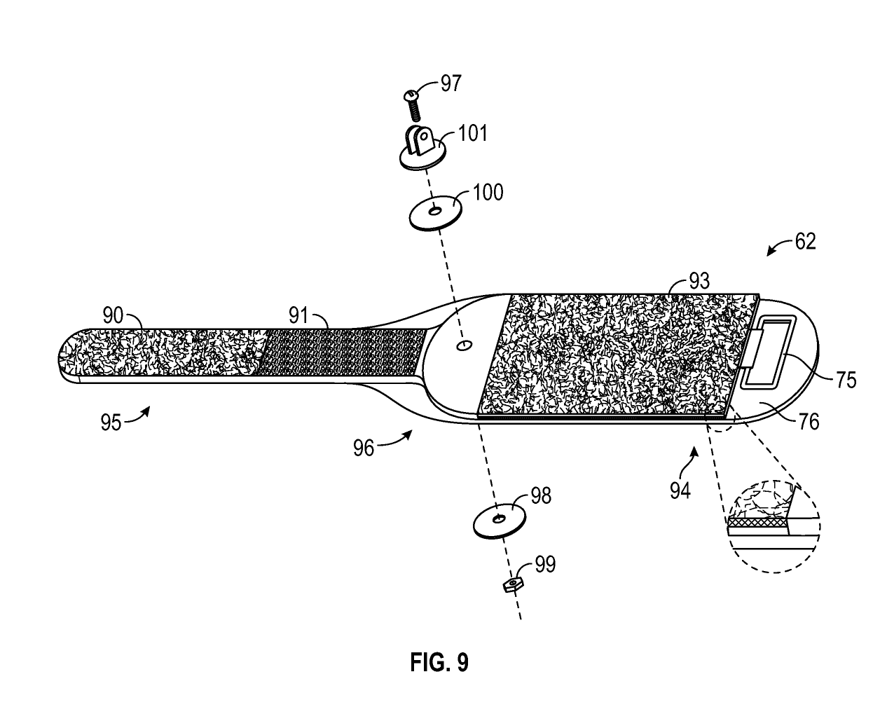

The first section 62 is also here configured as an adjustable hand strap 76 and connected to the second section 64 using a pivoting arm 65. A buckle 75 (cf. FIGS. 8, 9) and two interlocking Velcro® (hook-and-loop) fasteners 90, 91 (cf. FIG. 9) allow to attach the hand strap 76 around the user's hand safely and according to the respective anatomy of the user's hand.

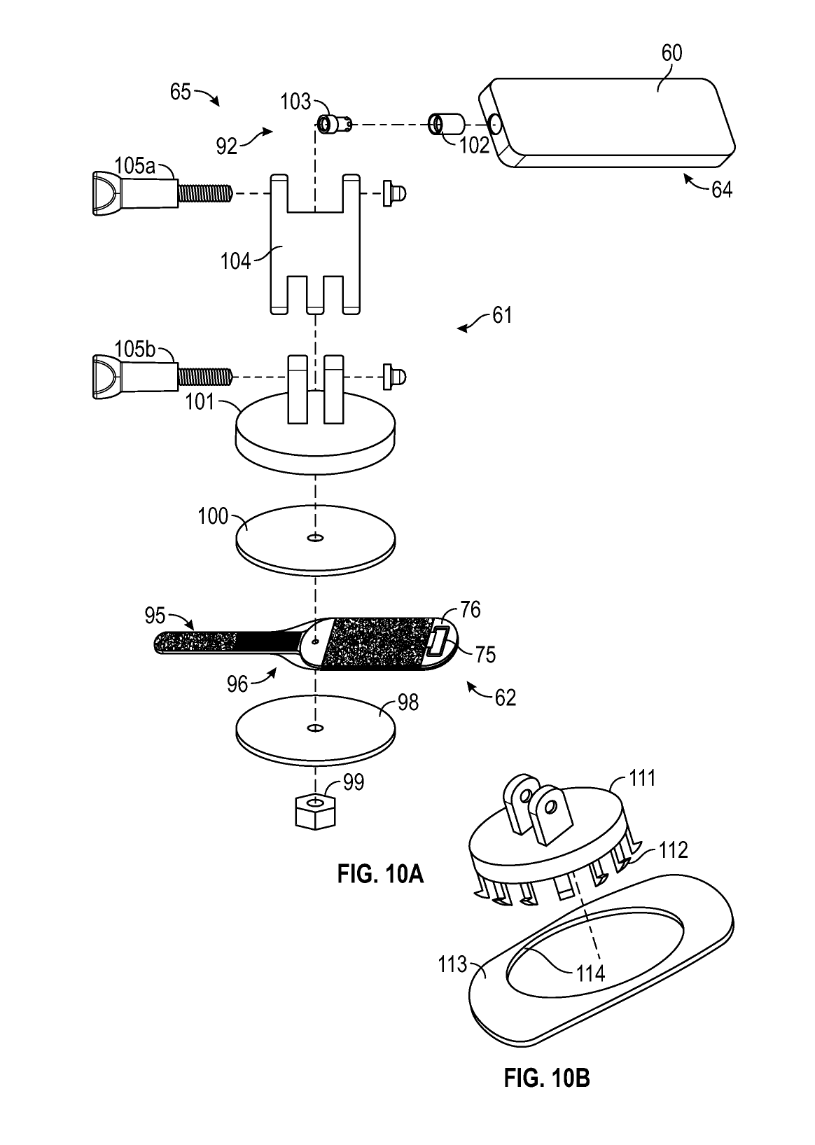

Referring again to FIG. 6 and besides the above discussed differing setup of the second section 64, the pivoting arm 65 according to the present embodiment is configured with a “dual-swivel” setup, allowing the second section 64 to pivot with respect to the first section 62 around a first pivot axis 66b and a second pivot axis 66c, which second pivot axis 66c is arranged parallel to said first pivot axis 66b. The pivoting arm 65 accordingly comprises two pivot joints, which will be discussed in more detail in the following with reference to FIGS. 9 and 10.

The mobile electronic device holder 61 according to the present embodiment further comprises a detachable swivel connector 92 (not shown in FIGS. 6-8), arranged between the pivot arm 65 and the second section 64. The detachable swivel connector 92 allows to disconnect the second section 64 from said pivoting arm 65 and thus the smart phone 72 from the respective hand 9 of the user quickly and simultaneously allows to pivot said second section 64 with respect to the pivoting arm 65 around a perpendicular swivel axis 66a, arranged perpendicular to said first 66b and second 66c pivot axes.

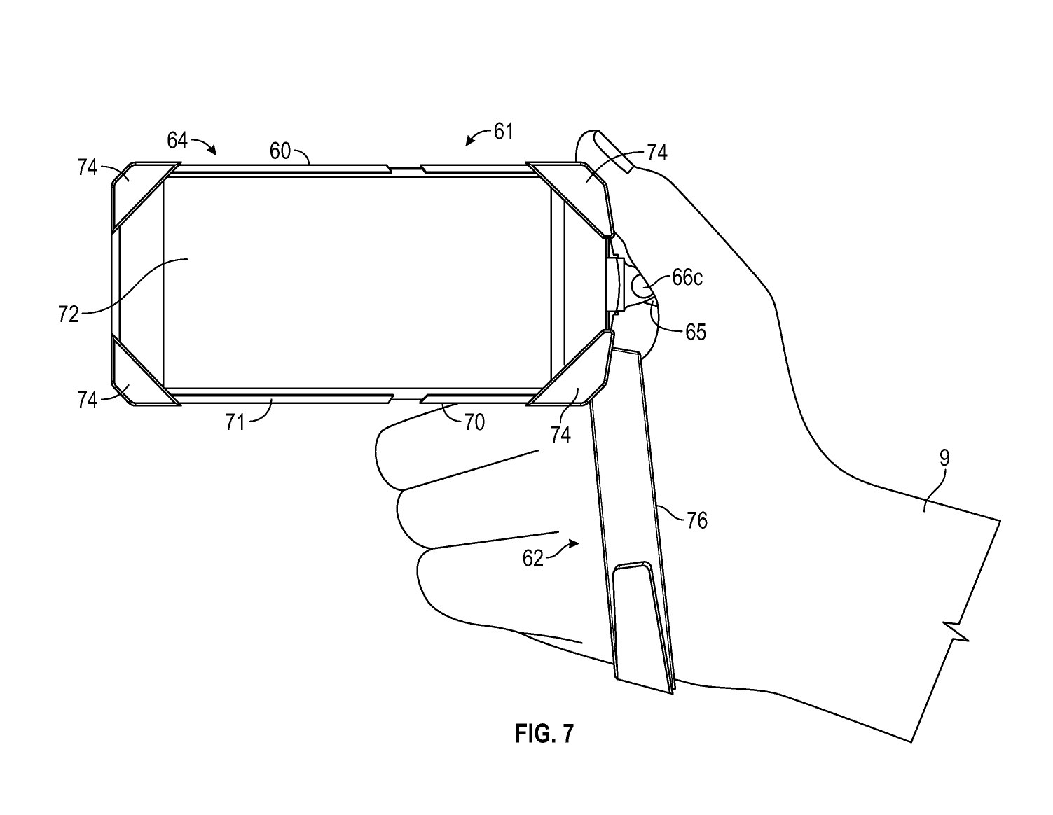

While FIG. 6 shows the mobile electronic device holder 61 and the connected smart phone 72 in the storage position, FIGS. 7 and 8 show the device holder 61 and the connected smart phone 72 in the handheld position according to a front and back perspective view.

FIG. 9 shows the first section 62 of the mobile electronic device holder 61 of FIGS. 6-8 in a perspective, partially exploded view.

The first section 62 comprises hand strap 76, as mentioned in the preceding. Hand strap 76 consists of multiple materials arranged in layers as shown in the enlarged portion of FIG. 9, namely, Velcro® (hook-and-loop) material, nylon webbing, and neoprene.

The hand strap 76 is optimized to fit 95% of user's hand sizes and is symmetrically balanced to be used with the right or left hand. The hand strap 76 can also be used to strap the mobile electronic device holder 61 to objects in the user's surrounding, as discussed in the preceding, due to the adjustable nature and orientation of the Velcro® fasteners. In addition to the already mentioned fasteners 90, 91, which allow the hand strap 76 to be attached safely to the user's hand, a further Velcro® fastener 93 provides that the smart phone 72 can be “latched” or “locked” in the storage position, and engages with a corresponding fastener on the back of the case 60 of the second section 64, as also discussed already in the preceding.

The large part of the hand strap 76 comprising the fastener 93 is also referred to as the “mobile interface” 94 in the following. The thickness of the mobile interface 94 is roughly twice the thickness as the remainder of the hand strap 76 that interfaces with the palm of the hand during use.

The mobile interface 94 is comprised of three layers: the layer that interfaces with the user's hand is a softer material, such as neoprene, the middle layer is a more rugged layer, such as nylon webbing, and the top layer is the Velcro® fastener 93 that interfaces with the smart phone 72 or case 60 of said second section 64.

On one end of the mobile interface 94 is a plastic (composite or metal) buckle 75 or loop, that the end of the “palm interface” 95 latches into. The bottom soft layer of the mobile interface 94 continues under the buckle 75 such that the user's hand does not make contact with the buckle 75. At the other end of the mobile interface 94, a pivoting arm interface 96 is provided. The bottom soft layer of the mobile interface 94 continues through and slightly past the pivoting arm interface 96, so that the bottom assembly of the arm interface 96 does not make contact with the user's hand. This also serves as a junction between the pivoting arm interface 96 and the palm interface 95, so that the junction of the side of the user's hand and the user's thumb interfaces with a soft material rather than an abrasive one. The palm interface 95 of the hand strap 76 is comprised of two layers, a durable webbed nylon-style layer on the bottom and a layer of Velcro® on top. The Velcro® layer comprises two Velcro® hook-and-loop fasteners 90, 91, as discussed in the preceding. It is noted, that the Velcro® fasteners may be of dual-purpose hook-and-loop Velcro® material which can be connected at any point, of “hook type”, or of “loop type”. In the case of a use of “hook type” and “loop type” Velcro® material, it should be apparent that when two fasteners are supposed to engage with each other, one fastener should be of “hook type” and the respective other one should be of “loop type” Velcro® material.

For example and with respect to FIG. 9, the length of the palm interface 95 is split between half hook-type fastener 90 and half loop-type 91 fastener, with the end being hook-type, and the section closer to the pivoting arm interface 96 being of loop-type 91 so that this interface 95 can be folded back on itself and accordingly secured into place.

The pivoting arm interface 96 comprises a molded washer-type mechanism between the bottom soft layer and the top durable layer of the hand strap 76. The mechanism comprises a lower washer 98 and nut 99. On top of the pivoting arm interface 96, an upper washer 100 and a swivel mount 101 are arranged. The hand strap 76 comprises a through hole in the center to accommodate a pin or a screw 97 that the pivoting arm 65 may rotate on.

FIG. 10A shows a partial perspective and exploded view of the embodiment of FIGS. 6-9. FIG. 10A shows the pivoting arm 65 in more detail and together with the first section 62 and second section 64. As discussed in the preceding, the detachable swivel connector 92 is arranged between second section 64 and pivoting arm 65. The detachable swivel connector 92 according to the present embodiment comprises an off-the-shelf male cylindrical swivel member 103 with a locking mechanism that allows a 360° rotational movement around its longitudinal axis and thus the perpendicular swivel axis 66a. The member 103 comprises spherical locking members arranged circumferentially, comparable to a ball bearing. The locking members are pushed outwards in a radial direction by springs (not shown). A push-button-release (also not shown), allows pulling the locking members inwards to release the connection. The male swivel member 103 is commercially available from Uncle Mikes/Bushnell outdoor products under product no. MO10112 (1″).

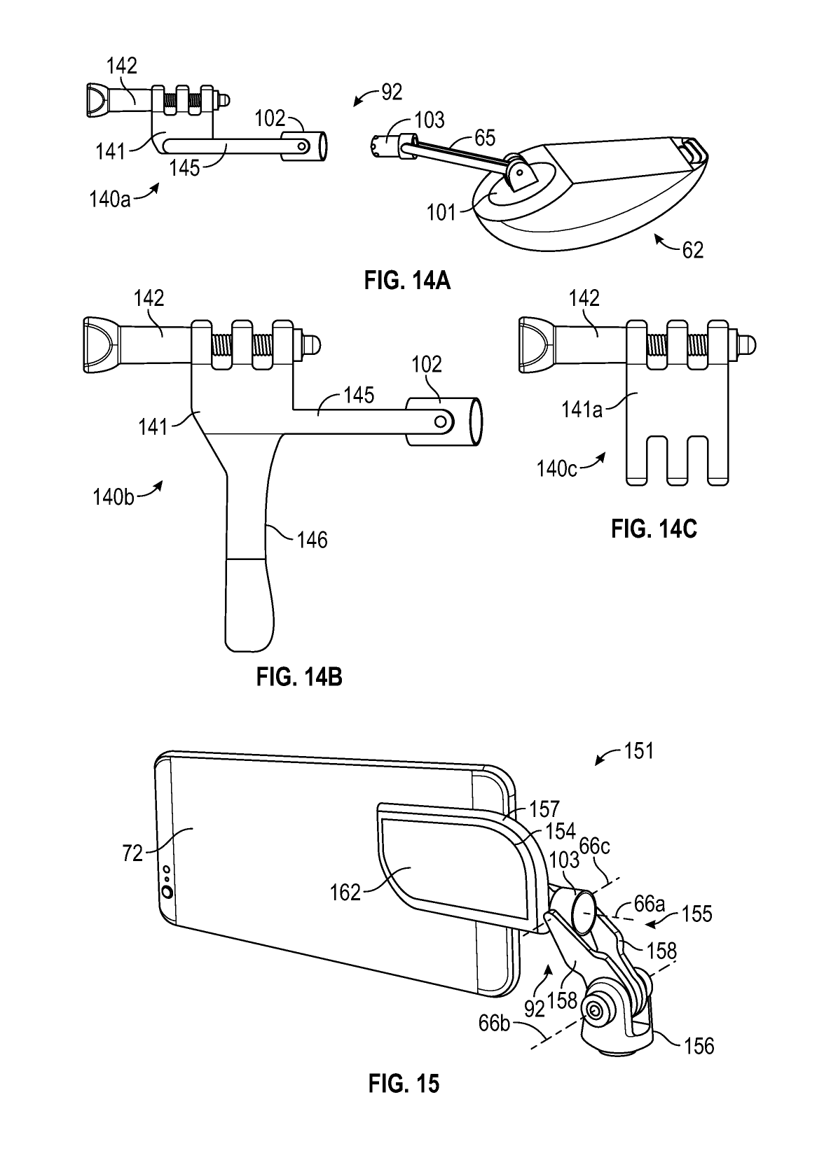

The detachable swivel connector 92 further comprises a female hollow, socket-like cylindrical swivel member 102, having a slightly larger inner diameter than the outer diameter of male swivel member 30, and comprises a radial groove on an inner surface for engagement with the locking members of the male swivel member 103. The female swivel member 102 may be embedded, e.g., adhesively bonded to the case 60 of the second section 64. In case of a set-like holder system, further female swivel members 102 may be provided, e.g., with universal mount adaptors, as will be described in more detail with reference to FIGS. 14A through 14C.

The male swivel member 103 is connected with hinge 104 of pivoting arm 65 via a hinge pin, which in this embodiment is a “thumb screw” 105a, to allow rotation about the second pivot axis 66c. The opposite end of hinge 104 is connected with swivel mount 101 over a further hinge pin/thumb screw 105b to allow rotation about the first pivot axis 66b. As discussed in the preceding, lower molded washer 98 with an embedded nut 99 is provided to lock the swivel mount 101 in place on hand strap 76.

An alternative embodiment of a swivel mount 111 is shown in FIG. 10B. Here, the swivel mount 111 comprises one-way hooks 112. A molded hand piece 113 has a channel 114 into which the swivel mount 111 locks. The molded hand piece 113 is connected with hand strap 76. Thus, the mounting hardware, discussed in the preceding with reference to FIG. 9, can be omitted.

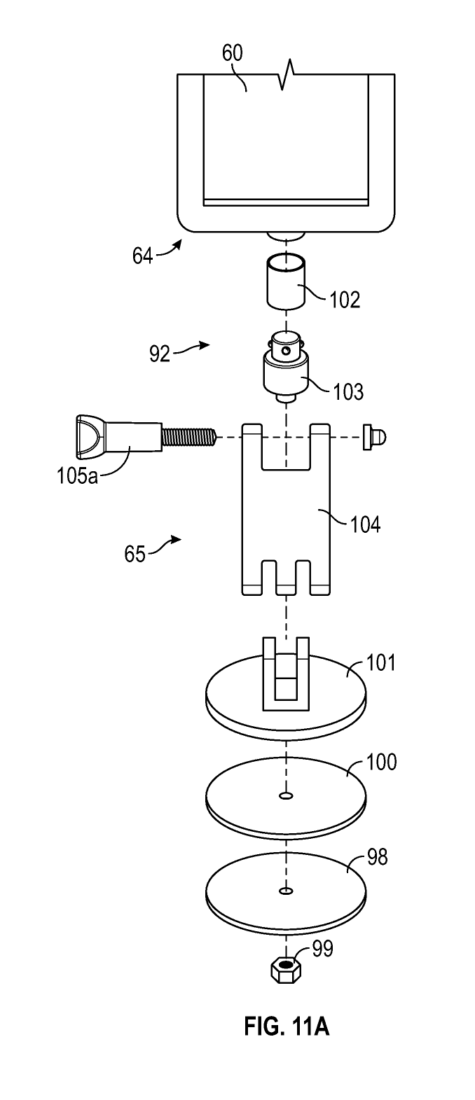

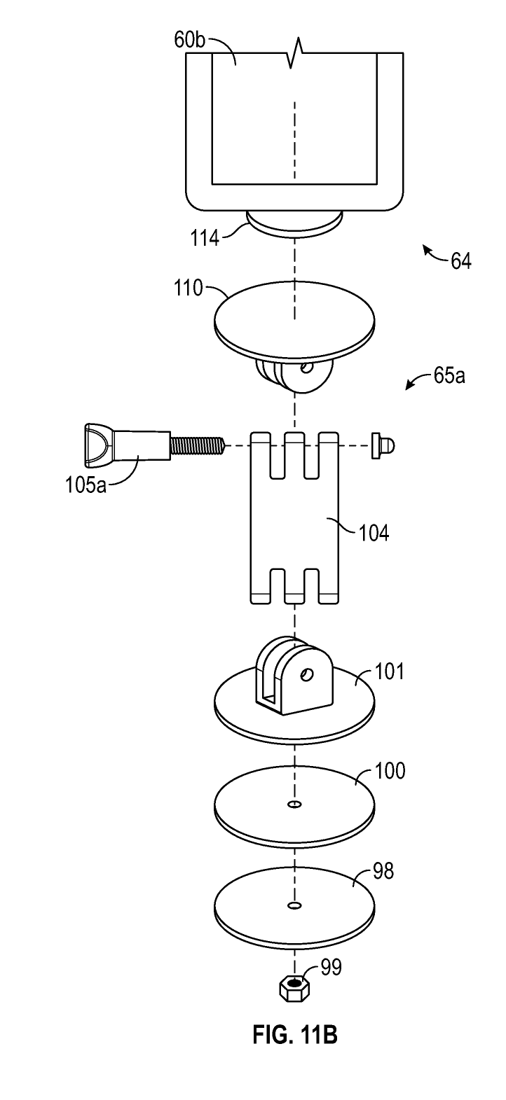

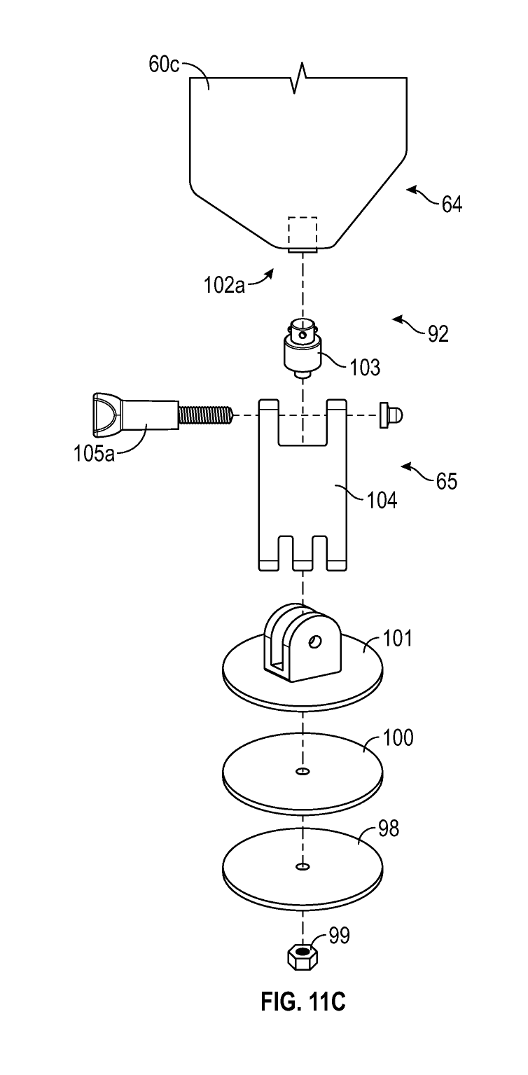

FIGS. 11A-11C show embodiments of the pivoting arm 65, 65a and case 60, 60b, 60c for use in a mobile electronic device holder 1, 11, 61 in partial and exploded views.

FIG. 11A shows the embodiment of FIG. 10A. FIG. 11B shows an embodiment, designed for a retrofit market. As can be seen from FIG. 11B, no detachable swivel connector 92 is present in this embodiment. Correspondingly, the pivoting arm 65a here does not allow for a quick disconnect of the second section 64 from the first section 62 and thus the smart phone 72 from the hand 9 of the user. Certainly, it may still be possible to disconnect the first section 62 from the second section 64 by removing at least one of the thumb screws 105a, 105b (not shown in FIG. 11B), e.g. to attach the mount adaptor 140c of FIG. 14C.

Instead of the detachable swivel connector 92, a second swivel mount 110 is provided, which attaches to the “retrofit” case 60b of the second section 64. The retrofit case 60b has an accompanied fitting 114, which is arranged perpendicular to the case and accommodates a pivot pin. The present embodiment thus is similar to the embodiment of FIGS. 3-4.

FIG. 11C shows a further embodiment of case 60c of second section 64 with a molded female swivel member 102a. The female swivel member 102a, as shown, is molded directly with the case 60c and thus formed integrally therewith. Alternatively, female swivel member 102a can be formed separately from the case 60c and then fitted into the case using the above-mentioned off-the-shelf assembly.

Each case 60a, 60b, 60c in FIGS. 11A-11C certainly has a Velcro® fastener on a back side (not shown) to attach to the first section 62 of the mobile electronic device holder 61 in the storage position as in the preceding.

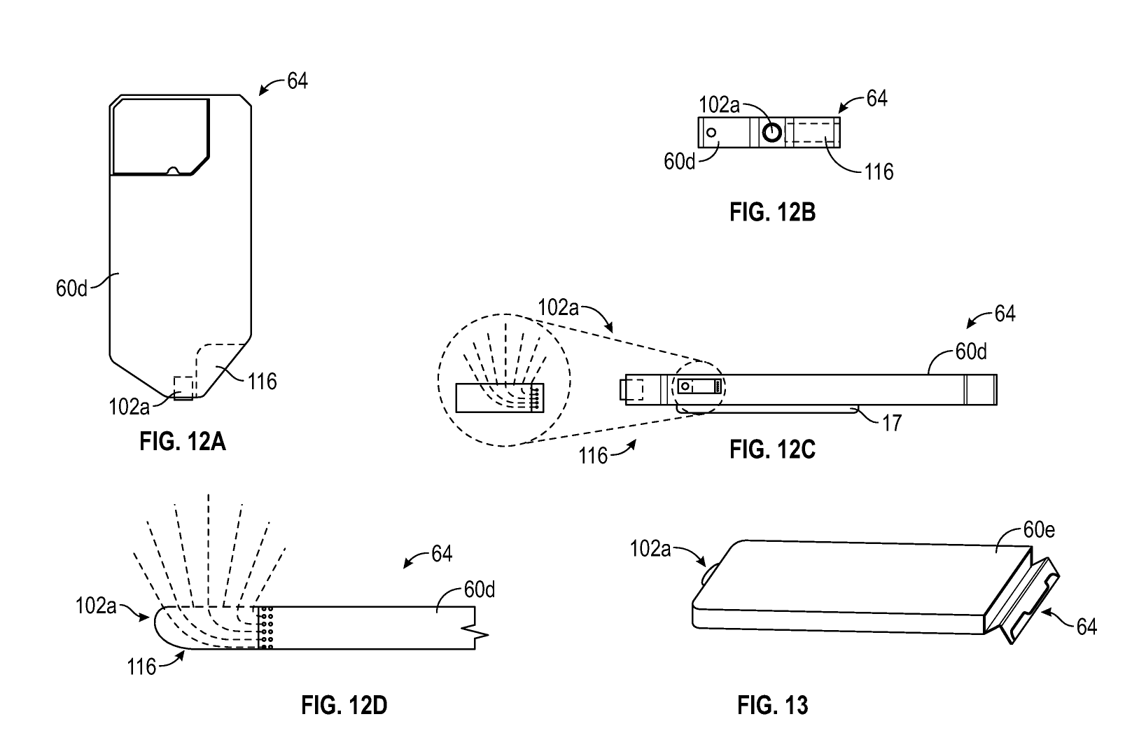

FIGS. 12A-12D show a further embodiment of a second section 64 of a mobile electronic device holder 1, 11, 61. The second section 64 comprises a case 60d for a smart phone 72, which case 60d corresponds to case 60c of FIG. 11C with the exception of an additional sound port 116 that has a slight ramp and cavity. Sound port 116 guides sound, such as in particular music that is emitted from the speakers of smart phone 72, which typically are located towards the bottom of the smart phone 72 and thus facing the female swivel member 102a when inside case 60d. The sound port 116 projects the sound of the speakers towards the front of smart phone 72, i.e. perpendicular to the drawing plane of FIG. 12A, so that the user can enjoy quality sound of his smart phone 72, even when the latter is received in case 60d. The sound port 116 according to the present embodiment is formed “scoop” or “ramp”-like, as in particular apparent from the enlarged portion of the side view of FIG. 12C. FIG. 12D shows a cross-sectional view of case 60d, while FIG. 12B shows an end view of case 60d.

FIG. 13 shows a further embodiment of a second section 64 of a mobile electronic device holder 1, 11, 61. The second section 64 comprises a case 60e for a smart phone 72, which comprises an opening top part, which allows sliding a mobile electronic device, such as smart phone 72, into case 60e and secure it subsequently. The case 60e can be a flexible sleeve or pouch that the smart phone 72 slides into. The case 60e can either be adapted with the detachable swivel connector 92 having female swivel member 102,102a, or the fixed swivel mount 110 (not shown in FIG. 13), as discussed in the preceding with reference to FIGS. 11A and 11B.

FIGS. 14A-14C show embodiments of a mount adaptor 140a, 140b, 140c. FIG. 14A shows a first embodiment of a mount adaptor 140a together with the first section 62 and pivoting arm 65, as discussed in the preceding with reference to FIGS. 6-13. According to the present embodiment, mount adaptor 140a is connectable to male swivel member 103 using a corresponding female swivel member 102, formed integrally with mount adaptor 140a. The mount adaptor 140a further comprises a hinge 141 and a locking pin 142, both of which are adapted for connection to a standard camera mount, i.e. in this example to the mount of a GoPro™ camera device. As can be seen from FIG. 14A, the hinge 141 is connected with female swivel member 102 over a 90° elbow 145.

FIG. 14B shows an embodiment of mount adaptor 140b, corresponding to the embodiment of FIG. 14A with the exception of a small handle 146 attached to the elbow portion of the 90° elbow 145.

FIG. 14C shows another embodiment of a mount adaptor 140c. The hinge 141a here allows connecting to a standard camera mount, i.e. in this example to the mount of a GoPro™ camera device, on one end, while the other end is adapted for connection to swivel mount 101 of the first section 62.

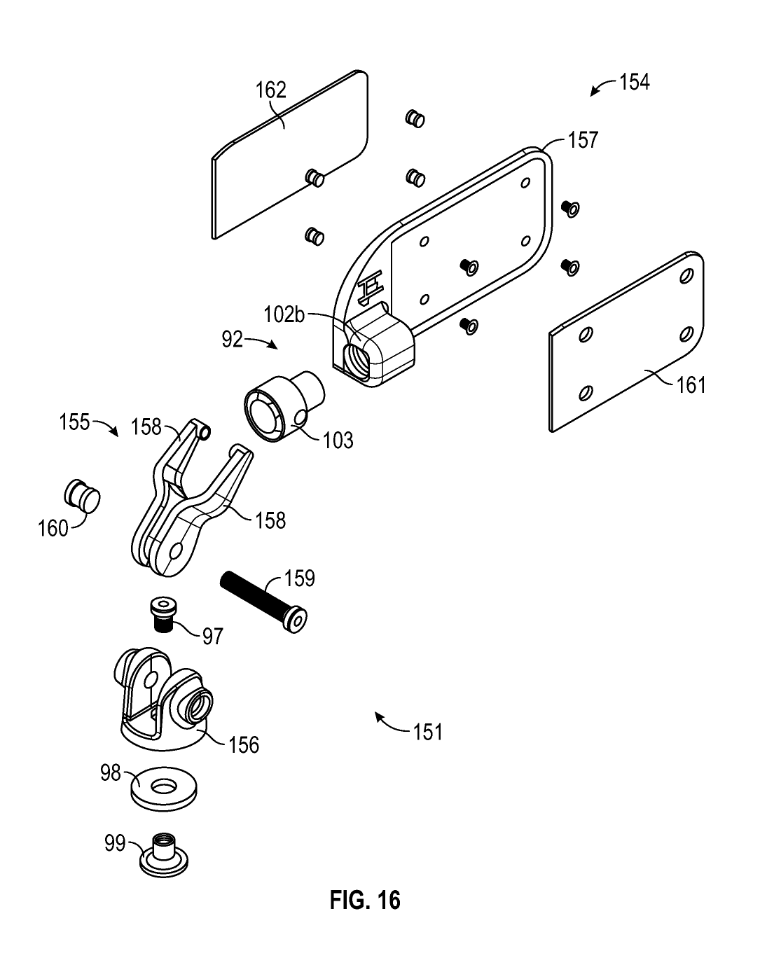

FIG. 15 shows a further embodiment of a mobile electronic device holder 151 in a perspective view. FIG. 16 shows the embodiment of FIG. 15 in an exploded view. In both FIGS., the first section is omitted so as not to obscure the present explanation. The first section may be configured according to one or more of the embodiments described herein.

As will be apparent from FIGS. 15 and 16, the second section 154 of the device holder 151 according to the present embodiment comprises a mounting plate 157, which is adhesively bonded with smart phone 72 (not shown in FIGS. 15-16). The mounting plate 157 is integrally formed with a female swivel member 102b, which connects to male swivel member 103, as discussed in the preceding. Male swivel member 103 is connected with pivoting arm 155, which according to the present embodiment comprises two brackets 158, which are pivotably coupled to swivel member 103 to swivel about second pivot axis 66c. The two brackets are on their other end rotatably coupled with swivel mount 156 to allow pivoting about first pivot axis 66b, parallel to said second pivot axis 66c. The detachable swivel connector 92 allows also here to pivot about a perpendicular swivel axis 66a, arranged perpendicular to said first and second pivot axis 66b, 66c.

Turning to the partial exploded view of FIG. 16, it will be apparent that the connection of swivel mount 156 to the hand strap 76 of the first section 62 (both not shown here) corresponds to the setup, shown in FIG. 9, namely using washer 98, nut 99, and screw 97. The pivotable connection between the brackets 158 and the swivel mount 156 is provided by hinge screw 159 and hinge nut 160. Phone 72 is connected with mounting plate 157 using an adhesive pad 161, such as manufactured by 3M Company and distributed as “VHB double sided adhesive”. On the opposing side of the adhesive pad 161, a Velcro® fastener 162 is arranged on the mounting plate 157 to allow to lock the smart phone 72 in the storage position on the back of the user's hand, as explained in the preceding.

While the invention has been illustrated and described in detail in the drawings and foregoing description, such illustration and description are to be considered illustrative or exemplary and not restrictive; the invention is not limited to the disclosed embodiments.
For example, it is possible to operate the invention in an embodiment, additional or alternative to the above, wherein
   the second section 4, 14, 24, 34, 44, 64, 154 instead of comprising a case, comprises a bracket, case, pouch, sleeve, mount, or any other type of device for a secure connection with or reception of said mobile electronic device,
   the second section 4, 14, 24, 34, 44, 64, 154 is at least partly made from a metal or polymeric material,
   tracks running on top of the second section 4, 14, 24, 34, 44, 64, 154 are provided, thus allowing the mobile electronic device to slide back and forth into adjustable positions, similar to the embodiment of FIGS. 5B and 5C,
   the second section 4, 14, 24, 34, 44, 64, 154 comprises an additional mobile device platform with hinges, so that the mobile electronic device can be brought into an upright position, i.e. perpendicular to the user's appendage,
   the second section 4, 14, 24, 34, 44, 64, 154 instead of being adapted to accommodate or connect with smart phone 72, is adapted to accommodate or connect with a mobile or cordless phone, a camera, a tablet computer, a smart watch, a wearable electronic device, a pager, a GPS device, a fitness tracker, a music player, or a similar mobile electronics or computing device,
   an additional thumb strap 3 and/or an additional wrist strap is provided,
   the thumb strap 3 and/or the wrist strap comprises a pouch, which is adapted to hold personal items such as credit cards, rings, or camera equipment,
   the thumb strap 3 and/or the wrist strap is removably connected with the first section 2, 12, 62,
   thumb strap 3 and/or the wrist strap is an independent pivoting strap which is connected to the hand strap 76 by two rivets in two different places allowing full swivel of the strap,
   the second section 4, 14, 24, 34, 44, 64, 154 comprises an auxiliary pocket or pouch allowing the user to slip the second section 4, 14, 24, 34, 44, 64, 154, e.g. when detached from said first section 2, 12, 62 on a rear view mirror, or place objects inside for safe keeping,
   the first section 2, 12, 62 comprises a removable remote control unit that connects to the electronic device and allows operation of various features such as, but not limited to the camera, music features, and flashlight, e.g., by connecting to the earphone jack via ⅛ inch adaptor, via USB, or via a proprietary connection of the respective mobile electronic device,
   the remote control unit comprises one or several buttons, which allow the user to use the features (take photo, play music, access voice commands) on the electronic device with a single hand,
   the remote control unit is attached to a finger strap that can be worn on the index finger and activated with the thumb,
   the remote control unit is removable from said the first section 2, 12, 62 and/or is wireless, to accommodate remote activation for various distances, e.g. when the electronic device holder is affixed to an inanimate object,
   the remote control unit comprises an integrated microphone for voice activation and recording video,
   the case of the second section 4, 14, 24, 34, 44, 64, 154 comprises removable corner retainer clips to allow to securely accommodate a mobile electronic device,
   the case of the second section 4, 14, 24, 34, 44, 64, 154 comprises a three part arm mechanism with hook-like features and a central pivot point for sizing adjustments,
   the case of the second section 4, 14, 24, 34, 44, 64, 154 comprises a four part attaching mechanism, which has a central ratcheting point intended for accommodating various sized mobile devices,
   the case of the second section 4, 14, 24, 34, 44, 64, 154 comprises a tray or case with accompanying Velcro® fastener inserts designed to fasten various sized mobile devices into place,
   the case of the second section 4, 14, 24, 34, 44, 64, 154 is a proprietary designed case, and/or
   the female cylindrical swivel member 102, 102a, 102b of the case of the second section 4, 14, 24, 34, 44, 64, 154 is configured for attachment to a key ring, or further stationary mounting device, such as a car attachment with a suction cup, a desk lamp design where there is a flexible neck, a desk charging station, or a flexible hose attached to a male swivel member 103, designed to coil and stand or wrap around an inanimate object.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single device, module, section, or other unit may fulfill the functions of several items recited in the claims.

The mere fact that certain measures are recited in mutually different dependent claims does not indicate that a combination of these measures cannot be used to advantage. Any reference signs in the claims should not be construed as limiting the scope.

What is claimed is:

1. A mobile electronic device holder comprising
a first section, configured for attachment to at least a user's hand; and
a second section, configured for connection with a mobile electronic device; wherein
the second section is movably coupled to the first section to provide at least a handheld position and a storage position of said mobile electronic device.

2. The mobile electronic device holder according to claim 1, wherein said first section is configured to be worn at least partly around the metacarpus of the user's hand.

3. The mobile electronic device holder according to claim 1, wherein said second section is pivotably coupled to said first section.

4. The mobile electronic device holder according to claim 1, further comprising a pivoting arm, coupled between said first and second sections.

5. The mobile electronic device holder according to claim 4, wherein said pivoting arm is coupled with said first section to pivot around a first pivot axis.

6. The mobile electronic device holder according to claim 4, wherein said pivoting arm is coupled with said second section to pivot around a second pivot axis and wherein said second pivot axis is substantially parallel to said first pivot axis.

7. The mobile electronic device holder according to claim 4, wherein said second section is coupled to said pivoting arm to pivot around a perpendicular swivel axis, arranged substantially perpendicular to the first pivot axis.

8. The mobile electronic device holder according to claim 1, further comprising at least one detachable connector to detach said first section from said second section.

9. The mobile electronic device holder according to claim 8, wherein said detachable connector is a detachable swivel connector.

10. The mobile electronic device holder according to claim 8, wherein said detachable connector is arranged between said second section and said pivoting arm.

11. The mobile electronic device holder according to claim 1, wherein said mobile electronic device holder is configured, so that in said storage position, said mobile electronic device is arranged in the area of the back of the user's hand.

12. The mobile electronic device holder according to claim 1, wherein said mobile electronic device holder is configured, so that in said handheld position, said mobile electronic device is at least partly positioned between the thumb of said user's hand and at least one further finger.

13. The mobile electronic device holder according to claim 1, wherein said first section comprises a first locking member and said second section comprises a second locking member, and wherein said locking members are configured to lock said mobile electronic device in said storage position.

14. The mobile electronic device holder according to claim 1, wherein said first section comprises a hand strap.

15. The mobile electronic device holder according to claim 14, wherein said first section further comprises a safety thumb strap and/or a safety wrist strap.

16. The mobile electronic device holder according to claim 1, wherein said second section comprises a receptacle for said mobile electronic device.

17. The mobile electronic device holder according to claim 1, wherein said second section is configured for permanent attachment to a mobile electronic device.

18. A mobile electronic device holder comprising a first section, configured for attachment at least to a user's hand and connectable to a second section, which second section is configured for connection with a mobile electronic device.

19. A mobile electronic device holder comprising a second section, configured for connection with a mobile electronic device and connectable to a first section, which first section is configured for attachment to at least a user's hand.

20. A method of mobile electronic device operation with a wearable electronic device holder comprising a first section, configured for attachment to at least a user's hand, and a second section, configured for connection with a mobile electronic device; wherein said mobile electronic device is brought from a storage position to a handheld position while being safely attached to the user's hand.
